(19) United States
(12) Patent Application Publication
(10) Pub. No.: US 2010/0251907 A1
(43) Pub. Date: Oct. 7, 2010

(54) FAT COLLECTOR

(75) Inventor: JUAN FERNANDEZ, TOWACO, NJ (US)

Correspondence Address: Gearhart Law LLC, 4 Ferndale Road, Chatham, NJ, 07928, US

(73) Assignee: PRODUCTS OF TOMORROW, INC., Towaco, NJ (US)

(21) Appl. No.: 12/753,922

(22) Filed: Apr. 5, 2010

Related U.S. Application Data
(60) Provisional application No. 61/211,975, filed on Apr. 6, 2009.
(60) Provisional application No. 61/280,061, filed on Oct. 28, 2009.

(51) Int. Cl. A47J 43/28

(52) U.S. Cl. 99/495

(57) ABSTRACT

The invention discloses a hand held fat skimmer, which includes an apparatus, consisting of a fat collecting section, a cooling section in thermal communication with the fat collecting section and a handle or gripping area. The apparatus may also include one or more triggers or scraper actuation mechanisms. The preferred embodiment of this invention is one in which the cooling section has a scraper mechanism. The scraper is disposed on the fat collection section. In an optional embodiment scraper is motorized. The scraper may be in mechanical communication with the handle and fat collecting section when then trigger is engaged or when the scraper actuation mechanism is moved. The fat collecting section may also consist of a cooling section in thermal communication with the fat collecting section and a handle or a gripping area. The apparatus can be expanded or collapsed. The cooling section can be expanded and collapsed. The apparatus may skim the surface of liquids or be pressed against solid foods, such as meat, thereby skimming off fat or grease.

### CLAIM OF PRIORITY

This application claims the priority of the U.S. Serial No. 61/280,061 filed on Oct. 28 2009, and of the U.S. Serial No. 61/211,975 filed on Apr. 6 2009, the contents of which are fully incorporated herein by reference.

### FIELD OF THE INVENTION

The present invention relates to devices for removing and collecting fat from food; in particular to hand-held fat skimmers.

### BACKGROUND OF THE INVENTION

The present invention relates to a handheld, portable device that is capable of removing fat from food. The present invention may be wrist operated, motor operated, or operated by hand with a help of a mechanical crank. The fat may be stored internally, to be discarded later.

The present invention is really useful in many applications. For example, one engaged in food preparation may reduce the fat content of traditionally greasy foods, like meat and poultry, by utilizing the present invention. Traditionally, the fat would be discarded, cut away or boiled out. However, these methods are very time consuming, resource intensive, and imperfect. While a chef making a small private meal may afford the time to drain access grease, commercial, high volume food establishments and party caterers do not have time or interest to limit the fat content of their dishes. For this reason, one attending a party or a meal purveying establishment may be served with dishes with higher than desired amount of fat. In such cases one may desire to have the present invention handy, so that one's dietary fat intake limits are not undermined by a requirement or desire to dine in social settings.

Additional downside of the prior art devices and methods is the general requirement that the fat be removed prior to cooking of the food. However, sometimes it may be desirable to cook a dish without removing the fat, either to enhance the taste or otherwise, but then to remove any access fat once the dish is done. Without the present invention, one would be required to wait until the dish has cooled to remove the fat but avoid removing the gravy. The present invention allows fat removal even when the food is warm or hot.

The present invention may also be very useful with previously refrigerated food. When dishes are hot or warm, gravy, juices and other seasoning are all mixed together as one liquid mass. However, fat tends to congeal at cooler temperature, or even at room temperature, and can then be removed to create a leaner and often, healthier dish. A proverbial spoon has been a medium of choice to remove such fat. However, using a spoon for this task is very laborious and inefficient. Additionally, another container must be utilized to discard the skimmed off fat. Also to be considered is that spooning-off is generally socially objectionable due to the highly repulsive and disrespectful perception of the activity. On the other hand, the present invention is capable of clearing large areas quickly and discretely and storing skimmed fat internally until it may be discarded at a more convenient time or location.

The present invention may be very useful for individuals with health problems that are exacerbated or even caused by fat content in foods. Most of such conditions involve cardiovascular and gastro internal maladies, but may involve other conditions as well, such as food allergies. A person dealing with these conditions must always be on guard so as not ingest anything that may make them sick. Such individuals are extra vigilant when not eating at home. The present invention may be used to mollify some of the apprehensions and risks that allergic individuals face when presented with social dining, since they are empowered to remove any objectionable fat, leaving healthy and safe dishes instead.

Several devices for removing or skimming fats are known. U.S. Pat. No. 5,077,900 relates to a fat skimmer in the form of a ladle having a deep vessel bowl with a rim at which there are ports for the transfer of surrounding fatty liquid into the vessel, determined by manipulation controlled by a locator associated with the rim. U.S. Pat. Nos. D252,068, D493,070 and D357,389 relate to fat skimmer devices to a fat skimmer for separating an unwanted fat liquid from a wanted liquid. The device consists of a transparent cone shaped jug for storing the unwanted fat liquid and the wanted fat liquid that is to be separated. U.S. Pat. No. 6,722,043 and publication application 2003/0188439 relate to a fat skimming ladle to use for removal of fat and other floating debris off of cooked soup stock. The ladle has a conduit structure with inlet located at the interior bottom of the ladle bowl and the outlet is located behind the proximal end of the handle. U.S. Pat. No. 7,172,705 relates to a skimmer device and a method for skimming a liquid, foam, fat or other solid or liquid material from a remaining liquid or solid that is left in the container using a strainer-type device.

There is a need for an inexpensive, large size or compact and portable fat skimmer that may be used at home or that may be portable and taken with the user outside the home.

### SUMMARY OF THE INVENTION

The invention discloses a hand held fat skimmer, which includes an apparatus, consisting of a fat collecting section, a cooling section in thermal communication with the fat collecting section and a handle or gripping area. The apparatus may also include one or more triggers or scraper actuation mechanisms. The preferred embodiment of this invention is one in which the cooling section has a scraper mechanism. The scraper is disposed on the fat collection section. In an optional embodiment scraper is motorized. The scraper may be in mechanical communication with the handle and fat collecting section when then trigger is engaged or when the scraper actuation mechanism is moved.

The fat collecting section may also consist of a cooling section in thermal communication with the fat collecting section and a handle or a gripping area. The apparatus can be expanded or collapsed. The cooling section can be expanded and collapsed. The apparatus may skim the surface of liquids or be pressed against solid foods, such as meat, thereby skimming off fat or grease.

Therefore, the present invention succeeds in conferring the following, and other not mentioned, desirable and useful benefits and objectives.

It is an object of the present invention to provide a device that is capable of skimming surface fat off food.

It is another object of the present invention to provide a device that is capable of reducing internal fat content of foot by squeezing it out of food item.

Yet another object of the present invention is to provide a device that is capable of storing the skimmed off fat within an internal chamber.

Still another object of the present invention is to provide a device that is capable of quickly congealing the skimmed off grease internally so as to prevent fat from seeping out of the internal storage.

Still another object of the present invention is to provide a fat skimming device that includes a hermetical cover, so that the skimmed off fat does not ooze out of the present invention, while the device is being stored.

Yet another object of the present invention is to provide a fat skimming device that is capable of preventing bad odors from escaping out of the fat storage container.

Still another object of the present invention is to provide a device that is capable of skimming fat off foods and provides a nifty handle that may be foldable and which prevents a user's hands and clothes from getting soiled with fat.

It may be another object of the present invention to provide fat skimming device that may be manually operated, mechanically operated or electronically operated.

### BRIEF DESCRIPTION OF THE DRAWINGS

FIG. 1 is a side view of the preferred embodiment of the present invention.

FIG. 2 is a side view of an alternative embodiment of the present invention.

FIG. 3 is an exploded view of the preferred embodiment of the present invention.

FIG. 4 is a transparent, perspective view of an embodiment of the present invention.

FIG. 5 is a cutaway view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

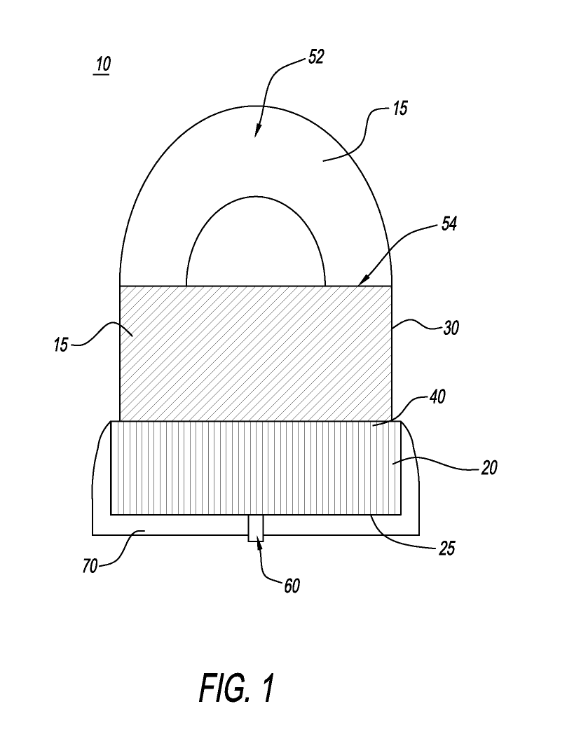

FIG. 1 is a side view of a preferred embodiment of the present invention. Shown are an apparatus 10, a sidewall 15, a fat collecting section 20, a base 25, a cooling section 30, thermal communication 40, a handle 50, hold area 52, mount area 54, a scraper mechanism 60, and a scraper 70. Preferably, the gathered fat or grease collects within the cooling section 30. However, a separate fat collecting section 20 may be included, especially in a larger embodiment of the present invention, such as an embodiment for home use. The preferred embodiment may be able to absorb between 4 ounces to 1 quart of grease. The size of the body comprised of either or both the fat collection section 20 and the cooling section 30 may be between 2.5 inches and 12 inches in height and between 2 inches and 10 inches in width or in diameter.

The present invention may be of many sizes, including a larger size for home use, and a smaller size for portable use for travel. The fat storage section 20 may be made in such a manner as to prevent the fat from leaking if the unit is not immediately cleaned or stored. Such a sealed container may be opened and closed by a screw-like mechanism or by a hinged-type mechanism (not shown). It may be sealed with the assistance of one or more O-Rings, or may be made of material that is self-sealing, thereby preventing leakage of the stored fat.

For ease of removal and cleaning as well as to prevent any leakage, it may be preferable to have the skimmed grease congeal as quickly as possible. Therefore, it may be preferred to collect the fat within the cooling section 30. However, a separate fat collecting section 20 may be used as well, as long at it is in close thermal proximity to the cooling section 30. Close thermal proximity is defined as when the chamber of the cooling section 30 is immediately next to and abutting the fat collection chamber 20. Thus, as the two chambers 20 and 30 move towards equilibrium temperature, the fat collection section 20 will gradually cool down as the cooling section 30 gradually warms up. The typical fats found in foods usually congeal at temperature that are lower than room temperature, thus as the temperature of the fat collection chamber 20 drops below room temperature, the skimmed fat within will congeal towards a solid state.

The cooling section 30 may be in any shape. It may be made of rigid material or collapsible material, such as rubber, which may aid in the storage and/or the portability of the apparatus 10. The collapsibility may be accomplished if the cooling section 30 is made of a plurality of horizontally or vertically attached angular ribs making up the side wall 15, that may fold into each other as in an accordion bellows, and that are capable of expanding when pulled apart, and contracting or folding, when pressed back together. There may be preferably one handle 50 as shown, or multiple handles 50 of various diameters or arc radian values or sizes. For example a smaller handle 50 or complete lack of it may be desirable for a smaller embodiment, while a larger device or an arthritic user may desire at least one hefty and thick handle 50, for a better grip. Both the handle 50 or handles and the cooling section 30 may be collapsible for storage or portability of the apparatus. When collapsed, one or more handles 50 may form a storage case for a portable version or for storage of the apparatus (not shown). In another embodiment, both the handle 50 and the cooling chamber 30 are capable of collapsing to form a storage case (not shown).

One or more handles 50 may be curved or ergonomically shaped in order to comfortably accept the human hand. One or more handles 50 may be coated with various materials known in the art to improve the grip and reduce slippage of the hand, including, but not limited to, rubber or silicone. In another embodiment one or more handles 50 may be made entirely of the material known to improve grip and reduce slippage of the hand.

Also, the apparatus 10 has a scraper mechanism 60 that contains at least one scraper 70, with a horizontal portion of the scraper 76 and a vertical portion of the scraper 78. The scraper mechanism 60 may be manually turned with a function of a wrist, or in another embodiment the scraper may move in a sweeping circular or pendulum motion or in any combinations of these maneuvers. For example, the apparatus 10 may be twisted either clockwise or counter clockwise, or the apparatus 10 may be dragged along the grease containing surface. In addition, the scraper mechanism 60 may be mechanically triggered or motorized, with the energy for such a motor supplied by batteries or a power cord (not shown). This fat collecting section 20, the cooling section 30 and the scraper 70 may be made of the same materials or different materials.

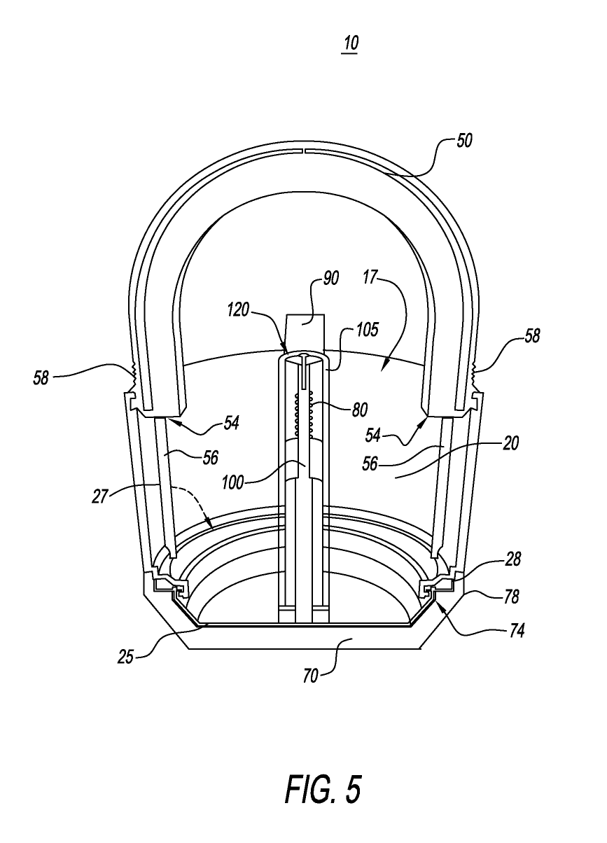

The apparatus 10 is intended to skim the surface of the food, since any melted fat is propelled towards the top as it is less dense than water. Therefore, if the scraper 70 is sunk too deep, it may wind up below the fat surface and ineffective. The vertical portion 78 of the scraper 70 is not strictly necessary, but is preferred, since it is able to corral any grease that has been pushed aside by the device or otherwise into the fat collection chamber 20 or the cooling chamber 30. The scraper mechanism 60 may be spring loaded as will be shown in later drawings. Alternatively, the scraper mechanism 60 may cause the scraper 70 to move back and forth in a pendulum movement or in a circular pattern. The actuation mechanism 120 (FIG. 5) may be spring loaded, mechanical or motorized. In an event of a motorized actuation mechanism 120, also known as in the art as power activated action, the switch (not shown) may be located anywhere on the device, preferably on the handle 50, where it would be easiest to reach.

There may be a separate motor and battery compartment which may be located anywhere on the apparatus 10, for example within the base 25 of the apparatus 10, or towards at the top 26 of the apparatus 10, in the cooling section 30 or within the handle 50. The motor and battery compartments may be located in the same or separate areas on the apparatus 10.

In another embodiment, a scraper actuation mechanism 120 is a button, trigger or a slide. The actuation button may be triggered to activate one or more spring coils 80 wrapped around one or more rods 100 and which functions to maintain the scraper 70 under tension against the bottom metal surface of the base 25. The scraper action may also swing in multiple directions, like a pendulum or move in sweeping motions. The scraper 70 may move fat or grease up the surfaces of the fat collection section 20 and store the fat or grease therein. The scraper 70 may be fixed and the body of the apparatus 10 rotates or moves in some direction, providing for the removal of fat. In such an embodiment the handle 50 may be the only part that is stationary, with the rest of the apparatus 10 swinging or rotating about the handle 50.

The fat collecting section 20, which preferably thermally communicates with the cooling section 30, may have a silicone rim on the base 25. Furthermore, the base 25 may be of any shape, and may have tapered or flared edges. In another embodiment, the base 25 acts as a stand for the apparatus 10 when the unit is not in use or to house a retractable scraper 70.

The scraper 70 is shown stretched along the entire base 25 of the fat collection section 20. Such a scraper 70 may be composed of two sections that are intersected in the middle by the scraper mechanism 60. Alternatively, there may be only one half of the scraper 70, which would emanate from one side of the activating mechanism 60. A single half scraper 70, may be significantly cheaper, and slightly gentler on the texture of the food, but may also need more time to achieve the same result as a full scraper 70 as shown.

The apparatus 10, its body, handle and accessories may be made from any material, including but not limited to: one or more metals, plastics and resins including but not limited to plastic, rubber, foam, silicone, ABS, Polycarbonate, Noryl™, PVC, Polystryrene, ABS/PVC, PVC/Acrylic, Polysulfone, Acrylic, Polyethylene, Kydex™, PETG; glass, including but not limited to fiberglass, borosilicate, or quartz; wood; metals, including but not limited to iron, tin, aluminum, copper; rubber including but not limited to natural rubber, SBR, Isoprene rubber, Butadiene rubber, and Chloroprene rubber; or any combinations or composites of these materials or other materials and new materials that may be manufactured in the future. The parts to the present invention may be manufactured from identical or different components, and the body, which may be made up of a cooling section 30 and or a fat collection section 20, may be manufactured using differing components in different parts. In a preferred embodiment, the apparatus 10 is made of FDA approved food grade materials. In another embodiment, the apparatus 10 is made of dishwasher-safe material.

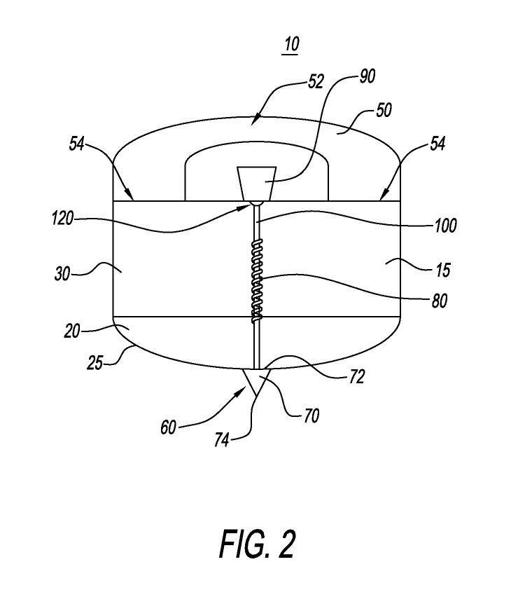

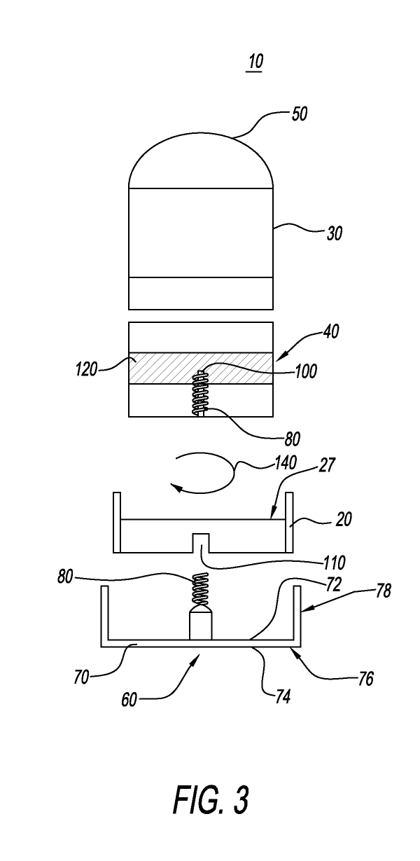

FIG. 2 shows one alternative embodiment of the apparatus 10 having a rounded or tapered base 25. Also shown are an outer wall 15, a fat collecting section 20, a cooling section 30, a handle 50, a hold area 52, a mount area 54, a scraper mechanism 60, a scraper 70, a plinth 72, a peak 74, a spring 80, a handle 90, a rod 100, and an actuation mechanism 120. The scraper 70 preferably has a plinth 72, which is a flat section of the scraper 70 and preferably abuts the base 25, and a peak 74, which is the sharper or pointed section of the scraper 70. The peak 74 is intended to dig into the food item and squeeze out any grease, not floating immediately at the top. As the scraper 70 moves forward, any extracted grease is pressed against the base 25 by the plinth 72, where it eventually enters the cooling section 30 or the fat collection section 20 through specialized openings (not shown) or a channel 110 (FIG. 3). Such action of the scraper 70 is preferred regardless of the embodiment. Therefore, although displayed in an alternative embodiment as shown, the scraper 70 would function similarly in other embodiments and in a preferred embodiment.

The fat collection maneuver is mechanically accomplished with an actuation mechanism 120 coupled with a scraper mechanism 60. The actuation mechanism 120, controls the motion of the rod 100, while the scraper mechanism 60 is attached to the scraper 70. These two mechanisms 120 and 60 act in unison, with the actuation mechanism 120 controlling the operation of the scraper mechanism 60, and preferably one may not be set in motion without moving the other. Actuation mechanism 120 varies based on whether it is manually operated with the handle 90, or whether it is motor driven (not shown).

The scraper 70 may encounter hard and sharp surfaces during operation, such as bones and cutlery. For this reason the scraper 70 must be sufficiently hard and durable and should preferably be made from a metallic material, or a polymer, wood or resin having profound strength, as well as shatter and damage resistant qualities necessary for proper enablement of the present invention.

The rod 100 functions as an axle or an arm of the present invention. The rod 100 needs to be substantially stiff and shatter resistant, since it is subjected to substantial pull and twist forces as the device operates. Preferably the rod 100 is self lubricating due the presence of food grease throughout the moving parts. However, some amount of machine based lubricants may be required and would be enclosed by hermetic seals (not shown) to prevent toxins from leaching into food. Preferably, the rod 100 is made out of the same material as the scraper 70 or of a different hard, stiff or snap resistant material. The rod 100 may be integral and monolithic with the scraper 70 and/or the scraper handle 90 (or simply handle 90), or any other part of actuating mechanism 120. Alternatively the rod 100 may be cramped, fastened to, threaded onto, welded or crimped together with either the scraper 70 or the handle 90. All of the moving parts of the present invention, such as the actuation mechanism 120 or the scraper mechanism 60 may be disassembled partially or completely for servicing and cleaning.

Surrounding the rod 100 is a spring 80. The spring 80 may have different functions. For example, in an embodiment where the scraper mechanism 60 is capable of burrowing deeper into a food item or a later of fat by separating from the base 25, the spring 80 may be used to retract the scraper mechanism 60 and to make sure that the plinth 72 of the scraper 70 is exerting upward pressure on any accumulated fat later. In another embodiment, the actuation mechanism 120 may be spring loaded, meaning that the spring 80 may be a wind-up spring that may wound by either turning the handle 90, or the scraper mechanism 60. In such a case a release mechanism may be provided or the scraper 70 may be held in one's hand or tightly pressed against a dish or food surface, while the spring 80 is in stand-by. Once the winding is complete and the device is disposed above the fat later, the spring 80 may be released by a mechanism or otherwise, in order to accomplish the fat skimming circular or swinging maneuver of the scraper 70.

Still referring to FIG. 2, shown is an embodiment of the present invention having an inwardly flared base 25. This embodiment may be operated by swinging the entire apparatus 10 in pendulum like motions or by swinging the scraper 70 by itself. The scraper mechanism 60 may also be able to turn along with the pendulum motions, for a more effective operation of the present invention.

FIG. 3 is an exploded view the present invention. Disclosed are an apparatus 10, a fat collecting section 20, fat reservoir 27, a cooling section 30, thermal communication section 40, a handle 50, a scraper mechanism 60, a scraper 70, a plinth 72, a peak 74, a horizontal portion 76, a vertical portion 78, a spring 80, a rod 100, a channel 110, an actuation mechanism 120, and a direction of rotation 140.

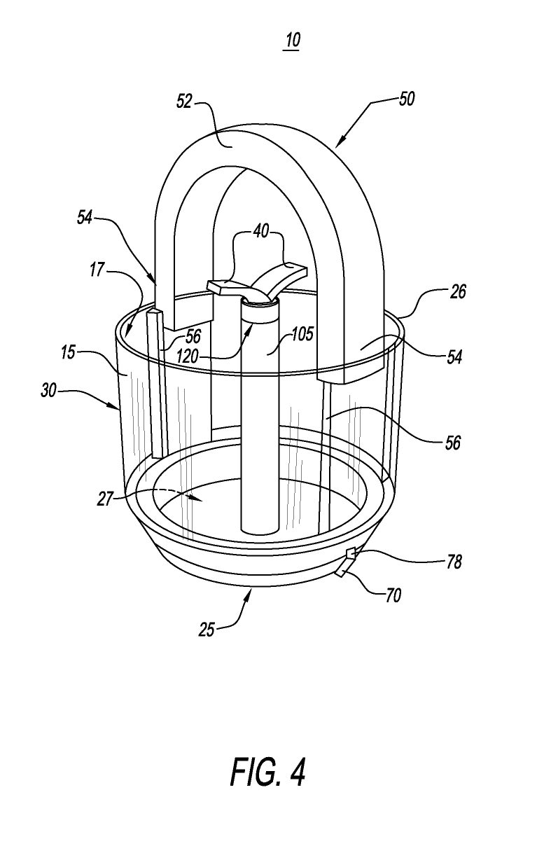

The apparatus 10 is shown having a cooling section 30 in thermal communication 40 with the fat collecting section 20. In one embodiment the cooling section 30 may accept at least one preformed coolable insert. The preformed coolable inserts may be a freezable gel pack. A coolable insert is essentially an ice pack that is filled with liquid and that may or may not be toxic if spilled out. A coolable insert may be preferable since it does not turn into water as it melts, and may be reused multiple times. Such an ice pack may be custom formed for use with the apparatus 10, such that it fills up as much of the coolable section 30 as possible, so as to achieve the most effective thermal communication with the fat collection section 20. The thermal communication section may be a point of attachment 40 between the cooling section 30 and a fat collecting section 20. Additionally, a coolable insert 130 (FIG. 4) may maintain a colder temperature than frozen ice, thus resulting in an overall cooler equilibrium temperature of the apparatus 10. The thermal communication section is essentially a separator between the cooling section 30 and the fat collection section 20. There is no preferred method of forming a communication section 40, and in its basic preferred form it may be a hermetic separator between the chamber of the cooling section 30 and a fat collection section 20.

In FIG. 3 the rod 100 is split into two to produce a clearer diagram. Although the rod 100 may be formed out of multiple sections, it is preferably a single piece. In the embodiment shown, any grease or fat gathered by the scraper 70 is corralled by the plinth 72 into the channel 110. Other openings, besides the channel 110 may exist to accept the inflow of grease. The actuation mechanism 120 shown in the diagram may be a spring loaded tension mechanism already described above, or an electric motor. One skilled in the art would appreciate that a separate trigger switch or mechanism, along with a battery pack, or another source of power, may be disposed within the actuation mechanism 120, or within any other part of the apparatus 10. The direction of rotation 140 may be clock-wise, counter-clockwise, in an oscillating motion or as a pendulum. The aim of the invention is to cover as much fatty area as possible in a single sweep, before any free flowing grease can spread out to other foods, as it is being disturbed by the activity of the apparatus 10.

Alternatively the fat collection section 20 may be made to fit on a compound metal portion and may twist an internal spring 80 and gear mechanism (not shown) when pressed down, thereby allowing for slow winding and rewinding of the scraper mechanism 60. The base 25 may consist of a post 101 hitched by a spring 80, and dampened by oil allowing the gear mechanism to slowly turn the scraper 70.

FIG. 4 shows another embodiment of the present invention. Shown are An apparatus 10, an outer wall 15, an inner wall 17, a base 25, fat reservoir 27, a cooling section 30, a handle 50, hold area 52, mount area 54, rails 56, a scraper 70, a vertical portion 78, a scraper handle 90, a shaft 105, and an actuation mechanism 120.

The embodiment shown does not contain a separate fat collection section 20. Instead, the fat accumulates within the fat reservoir 27. In the present embodiment the fat reservoir 27 may contain a cooling insert 130, for example, having a cooling ring as shown.

Thermal energy tends to travel from hotter areas to cooler ones. Therefore, any accumulated fat, abutting the coolable insert 130, would become cooler as heat is lost in cooling the coolable insert 130. Thereafter, any section of fat next to the now cooler fat would have its thermal energy depleted by this fat section. The system will continue the cooling process until all parts of the apparatus are at equilibrium temperature, which would preferably be cooler than the temperature of the grease prior to skimming. It would also preferably be a temperature at which the fat would substantially solidify for easy disposal and cleaning of the fat reservoir 27.

Still referring to FIG. 4, the actuation mechanism 120 contains a dual leaf scraper handle 90 for convenient gripping and twisting motion of the scraper handle 90 and is encased within the shaft 105. The shaft 105 contains a fastener means for mounting the entire actuation mechanism 120, which may be a threaded surface or a snap in joint. Alternatively a power switch (not shown) for a motor driven scraper mechanism 60 may replace the scraper handle 90.

The base 25 is shown having an inwardly flared or tapered structure. Such structure may be optimal for burrowing into a food dish or accessing container where space may be constricted. The fat collected in corners and recesses of a container may then be gathered with the horizontal section 78 of the scraper 70 or by tilting the apparatus 10.

The handle 50 contains a holding area 52 and a mount area 54. Either the entire surface of the handle 50 or just the holding area 52 may contain frictional accents, sleeves or coating, as described herein. The mount area 54 may be permanently attached to the inner wall 17 or the outer wall 15 with either a fastener, glue or welding or it may collapsible or foldable. The embodiment shown in FIG. 4 contains a retractable handle 50 that is able to slide up and down between rails 56, within the inner wall 17. A snap or fixating rib 58 (FIG. 5) may be present to prevent a handle 50 from collapsing while the apparatus 10 is being utilized. Alternatively, the folding handle may get retracted by being within on a hinge (not shown) at the mount area 54. The hinge would permit a sideways folding of the handle 50. Although not shown, a separate cover may be inserted beneath the handle 50 and around the shaft 105, which would cover the fat reservoir 27. Such a cover would help avoid offensive odors and leakage from the grease and fat retained inside the apparatus 10.

FIG. 5 is a cross sectional cutaway view of an alternative embodiment of the present invention. A preferred embodiment would contain a cover (not shown) for the fat reservoir 27 and further contain a cooling section 30 that may be able to contain ice or accept a callable insert 130. Further shown in FIG. 5 is an apparatus 10 having an inner wall 17 of a fat collecting section 20, and further having a base 25 that functions as a bottom for a fat reservoir 27. A joint 28 secures the base 25 to the rest of the apparatus 10. This may be particularly useful for cleaning of the fat reservoir 27 or for repairing the actuation mechanism 120. The joint 28 may additionally contain a slot or a niche (not shown) for mounting the vertical portion 78 of the scraper 70, which may act to prevent excessive flex of a rotating scraper 70. This embodiment further illustrates a semi-rail assembly 79, where the base 25 juts out at a convex angle, and the vertical portion 78 contains a cooperating concave angle. The angular contact the base 25 and the scraper 70 would act to reduce scraper flex during operation.

Also shown in FIG. 5 are a handle 90, spring 80, a rod 100, a shaft 105, an actuation mechanism 120, a handle 50, that is collapsible within rails 56, and which further has fixating ribs 58, that prevent the handle 50 from sliding downward under pressure, thus frustrating an effort to extract deeper layers of grease. The handle 50, as shown, may be collapsed by compressing the two mount areas 54, so that the handle may clear cooperating fixating ribs of the inner wall 17.

The a scraper 70 is shown as a full width blade, having two a horizontal portions 76, one on each end of the scraper mechanism 60. There may be more than one horizontal portion 76, such as three or four pronged horizontal portion (not shown), and a vertical portion 78. The rod 100 travels inside the shaft 105 and also inside the spring 80. A scraper handle 90 is shown capable of supplying the twisting motion of the actuating mechanism 120. The shaft 105 may hide a channel 110 for absorbing fat. The fat or grease may also enter the fat reservoir 27 through slots, channels or openings (not shown). It may be preferred that the scraper 70 is capable of rotating 360° degrees about the axis provided by the scraper mechanism 60. It is also preferable that the scraper 70 is capable of rotating clockwise, counter-clockwise, or swing like a pendulum within a channel.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An apparatus, comprising:
a fat collecting section;
a cooling section in thermal communication with the fat collecting section; and
a handle;
wherein the cooling section has a scraper mechanism.

2. The apparatus of claim 1, wherein the scraper is disposed on the fat collection section.

3. The apparatus of claim 2, wherein the scraper is motorized.

4. The apparatus of claim 2, wherein the scraper is in mechanical communication with the handle and the scraper the fat collecting section when then actuation mechanism is moved.

5. An apparatus, comprising:
a fat collecting section;
a cooling section in thermal communication with the fat collecting section; and
a handle;
wherein the apparatus can be expanded or collapsed.

6. The apparatus of claim 5 wherein the cooling section can be expanded and collapsed.

7. The apparatus of claim 5, wherein the handle is expanded and collapsed.

8. The apparatus of claim 5, wherein apparatus has a scraper, and the scraper is disposed on the fat collection section.

9. The apparatus of claim 8, wherein the scraper is motorized.

10. The apparatus of claim 8, wherein the scraper is in mechanical communication with the handle and the scraper the fat collecting section when the actuation mechanism is moved.

11. An apparatus, comprising:
a fat collecting section;
a cooling section in thermal communication with the fat collecting section;
a preformed coolable insert; and
a handle.

12. The apparatus of claim 11, wherein the preformed coolable insert is a freezable gel pack.

13. The apparatus of claim 11, wherein the cooling section can be expanded and collapsed.

14. The apparatus of claim 11, wherein the handle is expanded and collapsed.

15. The apparatus of claim 11, wherein apparatus has a scraper, and the scraper is disposed on the fat collection section.

16. The apparatus of claim 15, wherein the scraper is motorized.

17. The apparatus of claim 15, wherein the scraper is in mechanical communication with the handle and the scraper the fat collecting section when then actuation mechanism is moved.
